(19) United States
(12) Patent Application Publication
(10) Pub. No.: US 2014/0246394 A1
(43) Pub. Date: Sep. 4, 2014

(54) ADAPTER FOR CONNECTING A NIPPLE TO A BOTTLE

(71) Applicant: Phu Truong, San Francisco, CA (US)

(72) Inventor: Phu Truong, San Francisco, CA (US)

(21) Appl. No.: 13/784,344

(22) Filed: Mar. 4, 2013

(51) Int. Cl. A61J 9/00

(52) U.S. Cl. CPC A61J 9/00
USPC 215/11.1; 215/386; 29/428

(57) ABSTRACT

An adapter includes a neck with threads arranged to receive a ring that holds a nipple snug on the neck. A plurality of rings of threads is located within an interior of the adapter. Each ring of threads has a different diameter. The interior is tiered so that a first ring of threads closest to an opening at a bottom of the adapter has a widest ring diameter and a second ring of threads farthest from the opening at the bottom of the adapter has a narrowest ring diameter.

### BACKGROUND

Baby bottles are often used to feed babies expressed breast milk, infant formula, pediatric electrolyte solution or other liquids. To make it easy for infants to drink, baby bottles typically include a nipple, also called a teat, attached to a bottle by a ring.

### BRIEF DESCRIPTION OF THE DRAWINGS

FIG. 1 is a simplified diagram showing an adapter that can be mounted on various size bottles in accordance with an embodiment.

FIG. 2A and 2B are simplified diagrams showing that the adapter of FIG. 1 has different thread rings that allow for attachment to bottles with different neck diameters and different thread configurations in accordance with an embodiment.

FIG. 3 is a simplified diagram showing how a ring can attach a nipple to the adapter of FIG. 1, which can in turn be attached to a bottle in accordance with an embodiment.

FIG. 4 is a simplified diagram showing a ring attaching a nipple to the adapter of FIG. 1, and the adapter being attached to a bottle in accordance with an embodiment.

### DESCRIPTION OF THE EMBODIMENT

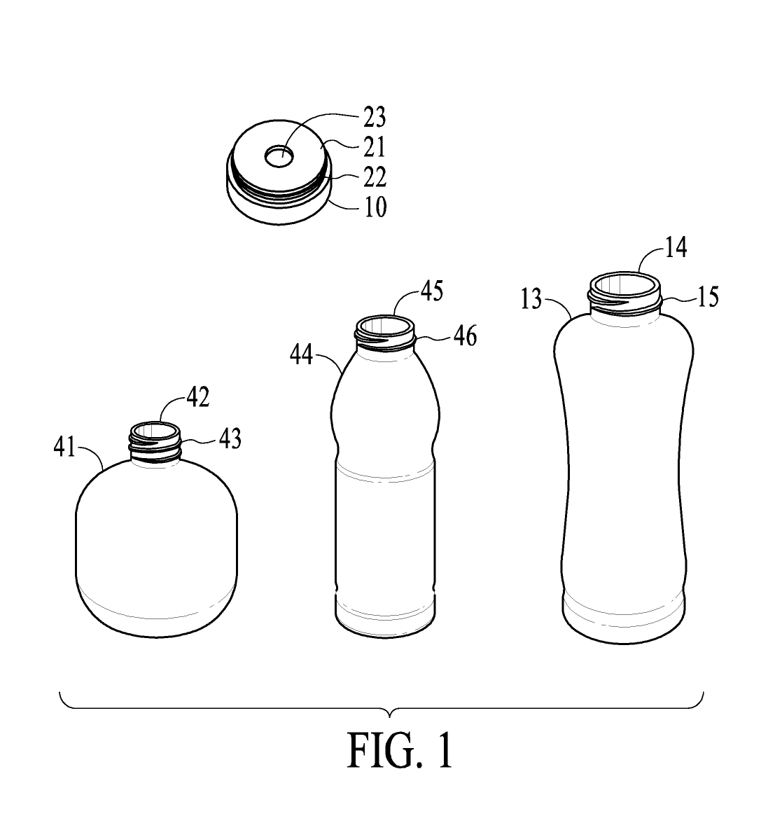

FIG. 1 shows an adapter 10 that can be mounted on various size bottles, such as a bottle 41, a bottle 44 and a bottle 13. For example each of bottles 41, 44 and 13 are composed of plastic, glass, stainless steal, or some other material suitable for creating a bottle. Bottle 41 includes threads 43 located on a neck 42. Bottle 44 includes threads 46 located on a neck 45. Bottle 13 includes threads 15 located on a neck 14. Each of the bottles shown in FIG. 1 has a different neck diameter and a different thread configuration. The variation in diameter size and thread configuration is meant to be illustrative and not limiting. For example, each of the bottles might have a neck finished to receive a standard cap size such as an SP 38 M 400; an SP 28 M400, an SP 24 M 410, an SP 24 M 415, or some other standard or non-standard neck finish defined by organization that defines or relies on standards such as the Glass Packaging Institute (GPI) or the Society of the Plastics Industry (SPI). For example in the term “SP 38 M 400”, the “38” refers to a cap diameter (in millimeters) and the “400” refers to the height and thread configuration necessary for closure.

Adapter 10 has a neck 21 with threads 22 configured to receive a standard ring for a baby bottle that holds in place a nipple arrange over a hole 23 in neck 21. For example adapter 10 is composed of plastic, rubber or some other material suitable for providing sealed attachment to a ring of a baby nipple and a bottle.

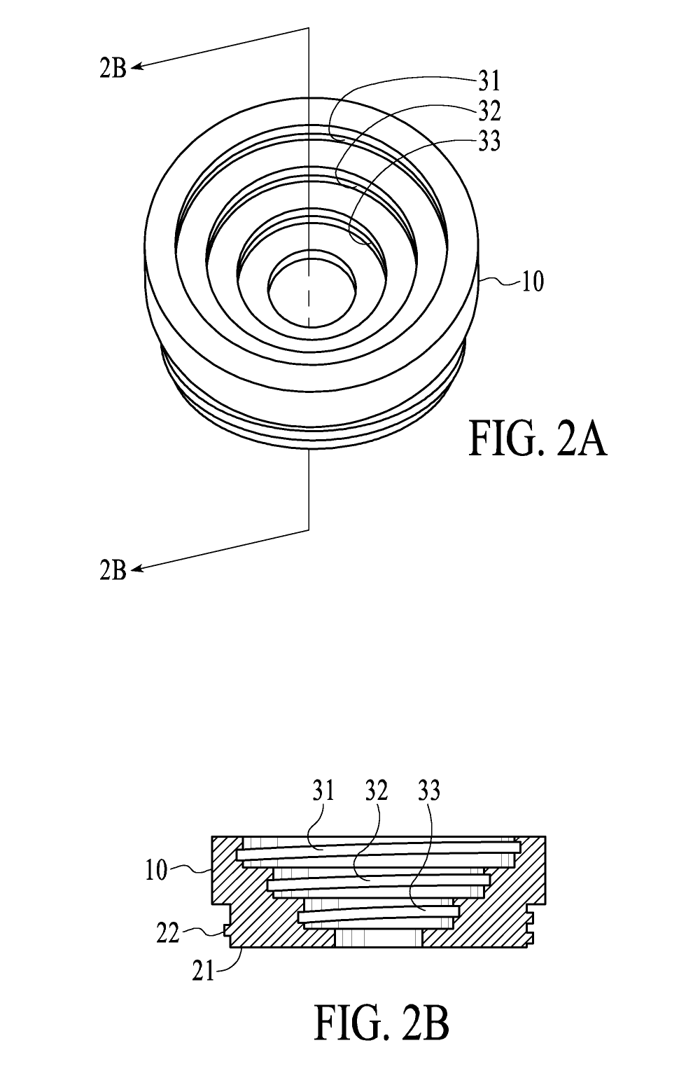

FIGS. 2A and 2B are simplified diagrams showing an underside and cutaway, respectively, of adapter 10. Adapter 10 is shown to have several rings of threads. The rings of threads each have a different diameter, and may have a different thread configuration. For example, ring of threads 31 might conform with an SP 38 M 400 cap, ring of threads 32 might conform with an SP 28 M400 cap and ring of threads 33 might conform with an SP 24 M 410. The different diameters and thread configurations allow adapter 10 to be snugly attached to bottles with different neck sizes and thread configurations.

While FIGS. 2A and 2B show three rings of threads, this is merely illustrative. Adapter 10 can be designed to have a different number of rings of threads, such as, for example, two, four or five rings of threads, each with a different diameter and some or all possibly having different thread configurations.

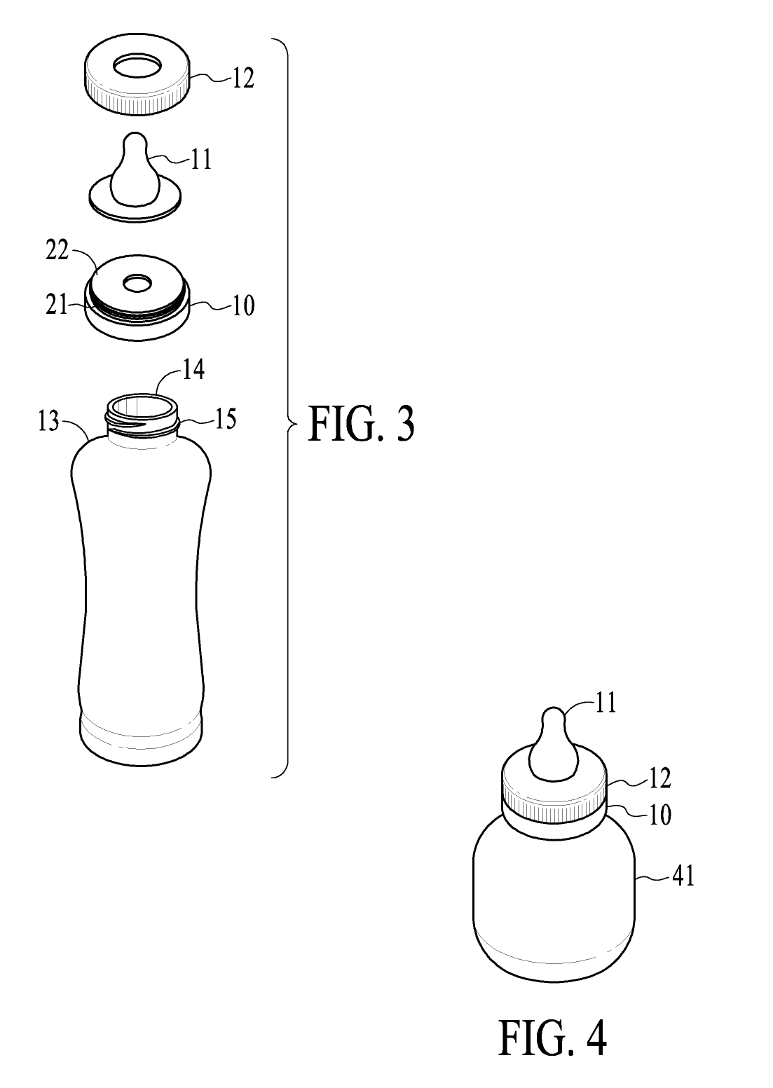

FIG. 3 shows a ring 12 used to attach a nipple 11 to adapter 10. Nipple 11 is placed over opening 23 of a neck 21. Ring 12 has threads (not shown) that when rotated engage with threads 22 of neck 21 to hold nipple 11 firmly over hole 23. Adapter 10 is placed over neck 14 and turned to engage threads 15 to create a sealed attachment of adapter 10 to bottle 13.

FIG. 4 shows ring 12 attaching nipple 11 to adapter 10. Adapter 10 has been placed over neck 45 and turned to engage threads 46 (shown in FIG. 1) to create a seal attachment of adapter 10 to bottle 44.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. An adapter comprising:
a neck with threads arranged to receive a ring that holds a nipple snug on the neck; and,
a plurality of rings of threads located within an interior of the adapter, each ring of threads having a different diameter, the interior being tiered so that a first ring of threads closest to an opening at a bottom of the adapter has a widest ring diameter and a second ring of threads farthest from the opening at the bottom of the adapter has a narrowest ring diameter.

2. An adapter as in claim 1 wherein each ring of threads in the plurality of threads has a different thread configuration.

3. An adapter as in claim 1 wherein at least two of the rings of threads in the plurality of threads has a different thread configuration.

4. An adapter as in claim 1 wherein there are three rings of threads in the plurality of rings of threads.

5. An assembled container, comprising:
a bottle;
a nipple;
a ring;
an adapter, including:
a neck with threads which holds the ring snug against the neck, the nipple being attached by the ring to the neck, and
a plurality of rings of threads located within an interior of the adapter, each ring of threads having a different diameter, the interior being tiered so that a first ring of threads closest to an opening at a bottom of the adapter has a widest ring diameter and a second ring of threads farthest from the opening at the bottom of the adapter has a narrowest ring diameter, wherein one of the plurality of ring threads holds the adapter snug to the bottle.

6. An assembled container as in claim 5 wherein each ring of threads in the plurality of threads has a different thread configuration.

7. An assembled container as in claim 5 wherein at least two of the rings of threads in the plurality of threads has a different thread configuration.

8. An assembled container as in claim 5 wherein there are three rings of threads in the plurality of rings of threads.

9. A method for assembling a container comprising:
attaching a nipple to an adapter with a ring;
attaching the adapter to a bottle using one of a plurality of rings of threads located within an interior of the adapter, each ring of threads having a different diameter, the interior being tiered so that a first ring of threads closest to an opening at a bottom of the adapter has a widest ring diameter and a second ring of threads farthest from the opening at the bottom of the adapter has a narrowest ring diameter.

10. A method as in claim 9 wherein each ring of threads in the plurality of threads has a different thread configuration.

11. A method as in claim 9 wherein at least two of the rings of threads in the plurality of threads has a different thread configuration.

12. A method as in claim 9 wherein there are three rings of threads in the plurality of rings of threads.
